(19) United States
(12) Patent Application Publication
(10) Pub. No.: US 2019/0373219 A1
(43) Pub. Date: Dec. 5, 2019

(54) METHODS, SYSTEMS, APPARATUSES AND DEVICES FOR FACILITATING MANAGEMENT OF EMERGENCY SITUATIONS

(71) Applicant: Sherry Sautner, Bakersville, NC (US)

(72) Inventor: Sherry Sautner, Bakersville, NC (US)

(21) Appl. No.: 16/425,676

(22) Filed: May 29, 2019

Related U.S. Application Data
(60) Provisional application No. 62/680,930, filed on Jun. 5, 2018.

(51) Int. Cl. H04N 7/18; H04W 4/90; G06K 9/00

(52) U.S. Cl. CPC H04N 7/181; G06K 9/00744; G06K 9/00718; H04W 4/90

(57) ABSTRACT

A system of facilitating management of emergency situations is disclosed. Further, the system may include a communication device configured for receiving a plurality of live video feeds related to the emergency situations from a plurality of user devices and/or transmitting the plurality of live video feeds and/or a ranking of the plurality of live video feeds to a security personnel device. Further, the system may include a processing device configured for analyzing the plurality of live video feeds to retrieve one or more video characteristics for each of live video feed in the plurality of live video feeds. Further, the one or more video characteristics may indicate a threat level associated with corresponding live video feed. Further, the processing device may be configured for prioritizing the plurality of live video feeds based on the one or more video characteristics to obtain the ranking of the plurality of live video feeds.

### FIELD OF THE INVENTION

Generally, the present disclosure relates to the field of data processing. More specifically, the present disclosure relates to methods, systems, apparatuses and devices for facilitating management of emergency situations.

### BACKGROUND

Even with increase in violence and danger, methods and systems to report incidents have remained unchanged. Individuals still need to make calls to emergency services. However, the individuals may not be able to contact emergency services at all times.

Further, individuals may not be able to provide an exact description of an incident. Further, individuals with disabilities may not be able to contact emergency services with ease due to a lack of functioning.

Further, existing systems to report incidents may not allow additional content, such as images or videos to be transmitted while reporting the incidents.

Further, existing systems to report incidents may not allow individuals to provide additional details, such as name, location, and so on to emergency service providers.

Further, existing systems to report incidents may not allow individuals to indicate additional details related to incidents, such as a degree of severity, such as life-threatening, to emergency service providers.

Further, existing systems to report incidents may not allow emergency responders to generate alerts based on incidents to other citizens.

Further, existing systems to report incidents may not allow data from additional sources, such as CCTV cameras to be included in the initial reports.

Therefore, there is a need for improved methods, systems, apparatuses and devices for facilitating management of emergency situations that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating management of emergency situations. The method may include receiving, using a communication device, a plurality of live video feeds related to the emergency situations from a plurality of user devices. Further, the method may include analyzing, using a processing device, the plurality of live video feeds to retrieve one or more video characteristics for each of live video feed in the plurality of live video feeds. Further, the one or more video characteristics may indicate a threat level associated with corresponding live video feed. Further, the method may include prioritizing, using the processing device, the plurality of live video feeds based on the one or more video characteristics to obtain a ranking of the plurality of live video feeds. Further, the method may include transmitting, using the communication device, the plurality of live video feeds and the ranking of the plurality of live video feeds to a security personnel device.

Further disclosed herein is a system of facilitating management of emergency situations. Further, the system may include a communication device configured for receiving a plurality of live video feeds related to the emergency situations from a plurality of user devices. Further, the communication device may be configured for transmitting the plurality of live video feeds and/or a ranking of the plurality of live video feeds to a security personnel device. Further, the system may include a processing device configured for analyzing the plurality of live video feeds to retrieve one or more video characteristics for each of live video feed in the plurality of live video feeds. Further, the one or more video characteristics may indicate a threat level associated with corresponding live video feed. Further, the processing device may be configured for prioritizing the plurality of live video feeds based on the one or more video characteristics to obtain the ranking of the plurality of live video feeds.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram representation of a system of facilitating management of emergency situations, in accordance with some embodiments.

FIG. 3 is a flowchart of a method of facilitating management of emergency situations, in accordance with some embodiments.

FIG. 4 is an exemplary representation of the system for facilitating management of emergency situations.

FIG. 5 is an exemplary block diagram representation of a security personnel device of the system for facilitating management of emergency situations.

FIG. 6 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of management of emergency situations, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, duplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, pass phrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplary disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

According to an embodiment, a system to facilitate live video alert of emergencies may be implemented through a web, computer, or mobile application. The application may be called as Live Crime/Emergencies Video Alert app and may be used by citizens, where the citizens may send, with a push of a button, live videos corresponding to an incident to local police stations and law enforcement officials in real time. Application users may automatically send video and/or images so that appropriate authorities may take the necessary action in time.

Further, to respond to an alert, a law enforcement officer may click on an alert which may include an indication of various degrees of urgency, and watch the video/photo of the reported incident. The application screen of the law enforcement officer may display up to 24 live video feeds, but not limited to, that may open and reveal a name and information of the citizen, and GPS location of the citizen. The officer may choose to text/call the citizen and provide any aid necessary. Additionally, in accordance with some embodiments, the application may enable the emergency service official to initiate and/or conduct a real-time communication using voice and/or video with the citizen by selecting the alert. For example, by clicking on a live video feed associated with the citizen, the emergency service official may initiate a real-time communication using voice and/or video with the citizen. Alternatively, in some instances, the citizen may initiate the real-time communication using voice and/or video. Further, the officer may also transmit the alert to any supporting agency, such as state and/or federal agencies to escalate the incident.

Further, police departments, municipality, law enforcement, sheriffs, schools, organizations, etc. may join/sign up on the application. The application may include multiple web pages for payment and sign up purposes only, after which, a citizen may be able to receive aid from a required agency for any incident. Further, if there is no response to an alert sent out by a citizen for a predetermined amount of time, the application may automatically facilitate a call to a 911 operator.

Further, the application may also allow citizens to receive live crime updates sent from the local law enforcement departments, so citizens may avoid the particular route/area. The live crime updates may be about robberies, thefts, arson, shootings, bombings, burglaries, assaults, vandalism, accidents, etc. within 50 miles to 250 miles radius of the location of the crime.

Further, the application may include multiple interfaces particular to the multiple types of users. For instance, the application may include a citizen interface. The citizen interface may include options such as splash, sign up/sign in, and dashboard. A user may download the app and may choose to sign up as a “Citizen” by adding details such as first name, last name, email, age, address, phone number, and gender. The system may verify the phone number of the citizen and may authenticate the user. After logging in, the user may be able to view the main screen with navigation options such as dashboard (news feed), my profile, incident detail, edit profile, record video (able to set urgency priority lights), take a picture (able to set urgency priority lights), subscriptions, notifications, settings, and history.

Further, the dashboard (news feed) may allow the user to receive and view live crime updates/feeds, along with incident location, within a predefined radius, such as 5 miles to 250 miles. The live crime update may be about robberies, thefts, arson, shootings, bombings, burglaries, assaults, vandalism, accidents, etc. A user may only be able to view such alerts when generated by one or more law enforcement officers.

Further, the record video/take a picture option may allow the user to take photos and record live videos within the application and upload on the application. The users may see a green light once a law enforcement officer has accessed the live video feed. Additionally, the user may be able to view how many officials are watching the live feed in real time.

Further, the incident report detail page option may allow the user to set urgency priority of an incident reporting using one or more lights, such as red (life-threatening), orange (a crime in progress with a chance of danger and or life-threatening), and yellow (a crime in progress or non-life threatening).

Further, the report (R-button) option may allow the user to record live video or capture photo of the event or crime scene at a specific location along with a short description (optional) which may be sent to a closest law enforcement officer or local official admin panel. The user may see a green light engage once a law enforcement officer has accessed the feed. A GPS coordinate may be sent along with the video or image so the right department can take immediate action on the same.

Further, the user may be able to chat with a law enforcement officer/authority via comments on live video or images.

Further, the alerts option may allow the user to receive alerts/warnings as well as special instructions as sent by law enforcement department within a radius set by a law enforcement officer/agency, such as a 250-mile radius.

Further, my profile option may allow the user to update the profile information, such as an address, subscription plan, and so on.

Further, the social sharing: (side menu) option may allow the user to socially share or advertise the application on social platforms.

Further, the subscriptions option may allow the user to choose one or more appropriate subscription plans.

Further, the settings option may allow the user to adjust additional settings, such as notifications, terms and conditions, privacy policy, and so on.

Further, the history option may allow the user to view a history of one or more incidents reported by him/her and a current incident. The user may be able to view the incident's videos/pictures and able to read comments.

Further, the user may be able to post success stories and post recommendations for other users and or law enforcement.

Further, the user can set up under settings a four-digit pin number that they only know in the event they wish to stop the Live video feed to officials. Once user stops video there is a push notification sent to law enforcement informing them the user has stopped the video being sent with a pin number.

Further, the notifications option may allow the user to receive and view notifications about one or more receipts, payment reminders for membership, notifications of incidents related to a local crime scene, and from an administrator.

The authorities/departments interface may include options such as splash, sign up/sign in, and dashboard. Authorities/departments, such as law enforcement agencies, fire departments, and so on, may be able to sign up by adding details such as, first name, last name, email, address with zip code, credit card info, upload id/license, no. of officials, official's role, and so on. Once a sign up is completed, authorities/departments may be able to sign-in into the application with given credentials and view the application dashboard for the particular department and may be able to make payments to renew services within the application, and generate sign-in credentials for one or more users (officers such as law enforcement officers, firemen, and so on).

Accordingly, one or more users may sign-in to the application with generated sign-in credentials.

The officer interface may include options such as splash, sign up/sign in, and dashboard. An officer may be able to sign-in and may view the main screen of the application along with multiple options such as homepage (dashboard), incident detail screen, user profile view, my profile, edit profile, settings, reported events, and history of reported events.

The dashboard option may list all incidents reported on the screen in a news feed way, displaying images or videos. By default, 24 cards may be loaded on the screen and officer may be able to load more cards by scroll down or with a load more button at bottom of the screen. The user can sort the list based on urgency. Tapping on any card item may take the user to the incident detail page.

Further, the Incident Detail Page may allow the user to view content related to an incident, such as thumbnail displaying name of an individual who may have reported the incident. The user may click on the thumbnail and open the profile of the individual. The user may make a call to the individual using the application. The user may mark the incident as resolved.

Further, once the user (officer) plays the video or views the image, the eye button will turn green and say “live” alerting the (citizen) that an officer is now viewing/watching the Live video report.

Further, an officer may be able to comment on the report and view comments by other users (citizens or officers). Further, a viewer count counter may also be included. The user may click on the counter, and open up a map displaying the viewers on the report, and the location of the viewers.

Further, the user may be able to transmit the report to one or more superior officials through the application, or as a link through an external application, such as email.

Further, the application may include an act button (A-button), which may allow the user (officer) to suggest one or more ways to avoid any harm near the incident to the individual (citizen).

Further, the user may be able to broadcast the event or crime scene as a warning or alert within any radius, such as 5-100 miles of radius to other recipients who may use the application. Further, the user may assign one or more warning alerts, such as Red, Orange, and Yellow to display a level of danger associated with the event or crime scene.

Further, the user may be able to escalate the reported event to state law enforcement, homeland security or federal bureau if needed by forwarding the video/picture link through the application, or through external applications such as email.

Further, the user profile view option may allow the user to view profile information related to an individual (citizen), such as first and last name, date of birth, phone number, email, full address, and current location.

Further, the my profile option may allow the user to make changes to the user profile, such as edit name, address, email and so on. Further, the user may be able to view initially added information, such as license ID, role, and so on.

Further, the settings option may allow the user to change settings of the application, such as set radius of incoming alerts, change notifications settings, and may include additional options such as terms & service, privacy policy, and so on.

Further, the history of reported events option may allow the user to view a history of incidents reported and resolved by the user, and allow the user to see a status of the incidents.

Further, an organization/establishment (such as hospitals, schools, corporations, and hotels) may be able to sign-up on the application. The organization/department may include one or more users (employees of the organization/establishment).

Further, the system may include an administrator. The administrator may be able to manage all users including departments/authorities. Further, the administrator may be able to view users, delete users, push out notifications of latest updates and other information, approve law enforcement sign up request, verify in-app purchases from server side, view all the citizen's activities, view all the local police/law enforcement activities departments and their officials, and view report of all the incidents reported, and completed by the authorities. Further, the administrator may be able to generate login credentials for authorities/departments, view analytics of the system, manage payments and website content, and track all the incidents reported by the citizens.

Further, the system may include facial recognition technology. Officers may be able to use external data banks for facial recognition to help find out information on users (citizens), and perpetrators. An officer may be able to enhance a broadcasted image/video by enlarging the image or video. The system may connect with a linked facial data bank for information on the perpetrator, and display the information through the application, overlapping the video/image.

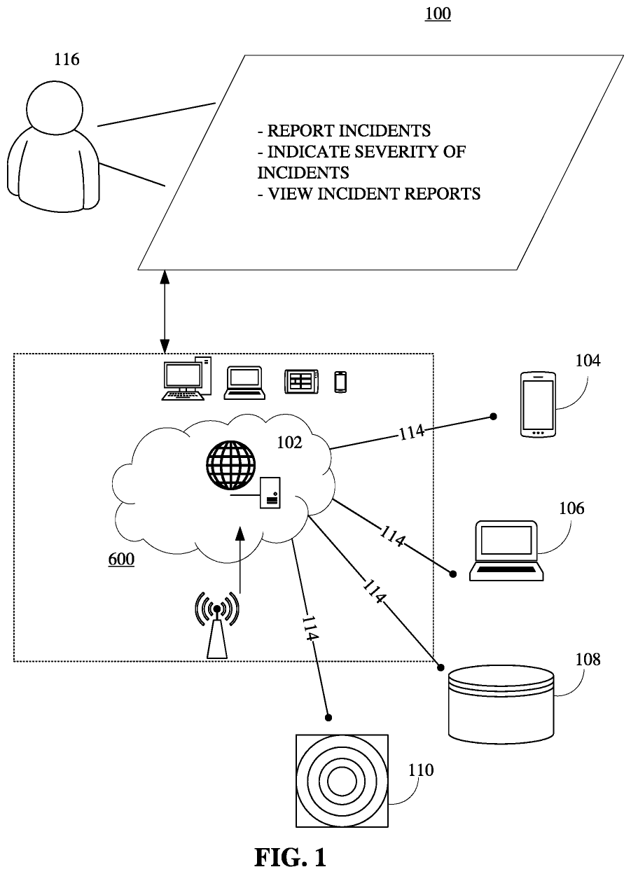

FIG. 1 is an illustration of an online platform 100 consistent with various embodiments of the present disclosure. By way of non-limiting example, the online platform 100 to facilitate management of emergency situations may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 over a communication network 114, such as, but not limited to, the Internet. Further, users of the online platform 100 may include relevant parties such as, but not limited to, end users, administrators, service providers, service consumers, and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 600.

According to some embodiments, the online platform 100 may communicate with a system (such as system 200) to facilitate live broadcast of an incident to concerned authorities. The live broadcast may include transmission of live videos and/or images and may be related to an incident, such as an automobile accident, domestic fire, criminal activity, terrorist activity, and so on. As such, the concerned authorities may include law enforcement, fire and rescue services, emergency medical services, emergency management, and public works.

The system may include one or more electronic devices. The one or more electronic devices may include one or more user devices such as, but not limited to, smartphones, computer tablets, laptops, and so on. The one or more user devices may include a communication device configured to communicate over a communication network such as, but not limited to, a cellular network, a satellite network, a personal area network, Bluetooth, Internet and so on. Further, the system may include one or more electronic monitoring devices, such as alarm systems, fire alarms. CCTV cameras and so on.

Further, the online platform 100 may allow users to create user profiles on the online platform 100. For instance, user profiles may include citizen profiles, emergency service official profiles, administrator profiles, and establishment profiles. The user profiles may include information about the users, such as name, age, gender, location, and so on. Further, information in the user profile may depend on the type of user profile. For instance, an emergency service official profile may include additional information such as a department to which the emergency service official may belong, such as a particular local, state, or federal law enforcement agency, a badge number, and so on. Further, administrator profiles may include administrative privileges, such as viewing profile information related to one or more users, allow one or more users to join, and so on, and may correspond to one or more departments.

The online platform 100 may receive, using a communication device, an incident report from a user device. The incident report may have been transmitted by a user, such as a citizen. Accordingly, the incident report may include one or more images or live video clips related to an incident. The incident may include a fire, an automobile accident, a criminal activity, and/or a medical emergency caused by aforementioned incidents. Further, the incident report may include details about the citizen, such as name, age, gender, and current location. Further, the incident report may include an indication of the severity of the incident, as indicated by the citizen. The indication of the severity of the incident may be provided by color-coded lights, such as red (life-threatening), orange (potentially life-threatening), and orange (non life-threatening).

Further, the online platform 100 may transmit, using the communication device, the incident report on one or more emergency service officials. The one or more emergency service officials may include one or more of law enforcement officers, 911 operators, and so on. The one or more emergency service officials may be located in the vicinity of the citizen. Accordingly, the one or more emergency service officials may view the incident report, and may proceed to aid the citizen.

Further, the online platform 100 may transmit, using the communication device, a notification to the user device of the citizen that one or more emergency service officials may have viewed the incident report.

Further, in an instance, the online platform 100 may facilitate communication between the one or more emergency service officials, and the citizen. The one or more emergency service officials may be able to call, or text the citizen, or may comment on the incident report to aid the citizen.

The one or more users, such as the citizen, and the one or more emergency service officials may access online platform 100 through a web based software application (referred to as application henceforth) or browser configured to run on the one or more user devices.

The application may allow a citizen to transmit incident reports including live videos/images corresponding to an incident to emergency service officials, such as law enforcement officers, firefighters, medical emergency personnel, and so on, in real time, as alerts, using a record video/take a picture option. Once an emergency service official has accessed the incident report, the application may notify the citizen, and may also notify of a number of emergency service officials who may be viewing the incident report.

Further, the application may allow the citizen to indicate a severity of the incident report using one or more lights, such as red (life-threatening), orange (a crime in progress with a chance of danger and or life-threatening), and yellow (a crime in progress or non-life threatening).

Further, the application may allow the citizen to message/call with one or more emergency service officials. Further, the application may allow the citizen to converse with the one or more emergency service officials through comments on the incident report.

Further, the application may include a dashboard that may allow the citizen to receive and view live crime updates/feeds, along with incident location, within a predefined radius, such as 50 miles to 250 miles, as transmitted by one or more emergency service officials. The live incident update may be about robberies, thefts, arson, shootings, bombings, burglaries, assaults, vandalism, accidents, etc. The citizen may only be able to view such alerts when generated by one or more law enforcement officers.

Further, the application may include an alerts option that may allow the citizen to receive alerts/warnings as well as special instructions as sent one or more emergency service officials.

Further, the application may include a report (R-button) that may allow the citizen to record live video or capture a photo of an incident, or crime scene at a specific location along with a short description (optional) which may be sent to an emergency service official.

Further, the application may include a history option that may allow the citizen to view a history of one or more incidents reported by the citizen.

Accordingly, one or more emergency service officials, such as law enforcement officers, firemen, medical emergency personnel, may access the application through one or more user devices, and view one or more alerts related to one or more incident reports. The application screen of an emergency service official, such as a law enforcement officer, a 911 dispatcher, etc. may display multiple alerts at a time in multiple windows displaying the incident reports transmitted by one or more citizens. In an instance, the number of windows displayed in the application screen of the emergency service official may be configurable. For instance, the application screen of a 911 dispatcher may display 24 windows corresponding to 24 incident reports by one or more citizens, displaying 24 videos/images included in the corresponding incident reports.

Further, to respond to an alert, an emergency service official may click on an alert (which may include an indication of a severity of the incident) and view additional information related to the incident, such as the one or more transmitted videos/images, name and information of the citizen who may have transmitted the videos/images, and a location of the citizen. Accordingly, the application may allow the emergency service official to message or call the citizen and provide any aid necessary.

Further, the application may include an incident detail page that may allow the emergency service official to view content related to the incident report, such as thumbnail displaying name of a citizen who may have reported the incident. The emergency service official may click on the thumbnail and open the profile of the citizen.

Further, the application may allow the emergency service official to contact the citizen through a call or through messages, or through comments. Further, in an instance, the application may allow the emergency service official to contact the citizen directly, while viewing the incident report and the included videos/images.

Further, the application may allow the emergency service official to transmit the incident report to one or more superior officials, or additional agencies. For instance, a law enforcement official of a local police department may transmit the incident report to one or more emergency officials related to a federal agency, such as the FBI.

Further, the application may include an act button (A-button) that may allow the emergency service official to suggest one or more ways to avoid any harm near the incident to the citizen.

Further, the application may allow the emergency service official to broadcast the incident scene as a warning or alert within a predefined radius, such as 5-100 miles of radius to other users, including one or more citizens and emergency service officials, and indicate a severity of the incident. Further, the user may be able to escalate the reported event to state law enforcement, homeland security or federal bureau if needed by forwarding the video/picture link through the application, or through external applications such as email.

Further, the application may allow one or more organizations such as police departments, municipality, etc. to join/sign up, and may allow one or more emergency service officials to be associated with the one or more organizations.

Further, in an embodiment, once an alert regarding an incident report is transmitted to one or more emergency service officials, the online platform 100 may determine if an emergency service official has viewed the incident report in a predetermined amount of time. If no emergency service official is determined to have viewed the incident report, the application may facilitate an additional call to emergency services, such as a 9-1-1 call. In an instance, the additional call to emergency services, such as a 9-1-1 call, may be performed after an amount of time indicated by the citizen, such as 2 minutes.

Further, in an embodiment, the online platform 100 may analyze, using a processing device, the videos/images included in the one or more incident reports and may determine a severity of the incident. For instance, the videos/images may be analyzed to determine one or more weapons, a number of weapons, and types of the one or more weapons present.

Further, in an embodiment, additional input, such as input received from one or more sensors, such as microwave and millimeter wave sensors, may be analyzed by the online platform 100 to detect concealed weapons, Further, the online platform 100 may determine one or more non-threat targets, such as unarmed individuals.

Further, the videos/images may be determined to determine the presence of one or more other harmful components, such as fire, smoke, electric wires, and so on. Further, the audio present in the videos may be analyzed to determine the presence of one or more harmful components, such as gunfire. Accordingly, the online platform 100 may change the severity of the incident reports. Further, in an instance, the online platform 100 may, through the application, transmit an incident report with a high determined severity to one or more emergency officials located near the incident along with an extra notification, such as a high volume ring.

Further, in an embodiment, incident reports may include additional information captured through sensors such as night vision sensors, thermal imaging cameras, and so on. Further, one or more emergency service officials, such as law enforcement officers may make use of sensors such as night vision sensors, thermal imaging cameras, and so on, and capture information included in incident reports, such as while tracking movements of one or more suspects. For instance, the incident reports may include videos (live videos, photos, etc.) that may be captured by a camera (such as a body cam that may be connected to the law enforcement's body), which may be transmitted in real-time to an administrative device for live viewing. Further, in some embodiments, the incident reports may include live videos being shot by drones associated with the law enforcement officer, which may be transmitted in real-time to the administrative device for live viewing.

Further, in an embodiment, the online platform 100 may enhance the information included in the one or more incident reports, such as videos and images, such as through post processing, to obtain additional information.

Further, in an embodiment, one or more organizations, such as hotels, schools, and so on who may register on the online platform 100 may link existing monitoring systems, such as CCTV cameras, burglar alarms, fire alarm systems, and so on to the profiles of the organizations provide additional data such as videos/images, and sensory data such as data received from smoke alarms, and so on. Accordingly, the additional data received from the one or more existing monitoring systems may be included in the incident report, and may be transmitted to one or more emergency services officials viewing the incident report.

Further, in an embodiment, the online platform 100 may connect with additional databases, such as criminal records maintained by one or more law enforcement agencies, such as Interpol and CIA, and so on, and may retrieve data from the one or more databases. Further, the data retrieved from the one or more databases may be used to determine an identity of one or more perpetrators involved in an incident, such as through facial recognition. Further, in an instance, information received from the facial recognition may be displayed as a text overlay over the information included in the incident report, such as images and videos.

Further, in an embodiment, the information related to an incident may be made public and may be shared with one or more users, such as citizens. Accordingly, the one or more users may be made aware of potentially dangerous situations. For instance, if a burglary has been recorded, and the burglar has been identified, the identity of the burglar may be shared with one or more citizens in the area.

Further, the online platform 100 may analyze one or more incident reports, and information included in the incident reports, such as images, videos, and/or location, and may determine one or more incident reports to pertain to one single event. Accordingly, the online platform 100 may store the one or more incident reports along with one or more appropriate tags and classifications.

Further, in an embodiment, the online platform 100 may transmit a notification to one or more users in the vicinity of an incident about the incident through the application. Further, the one or more users may be prompted with instructions from one or more emergency service officials on procedures and or places to go if the incident becomes threatening.

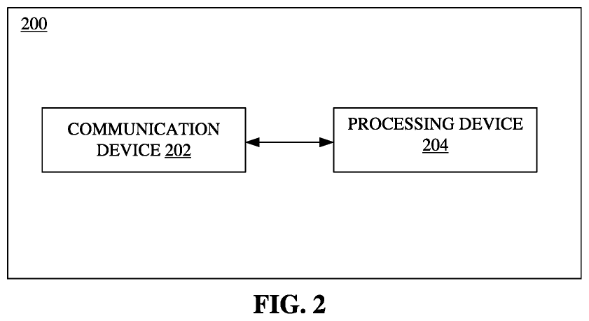

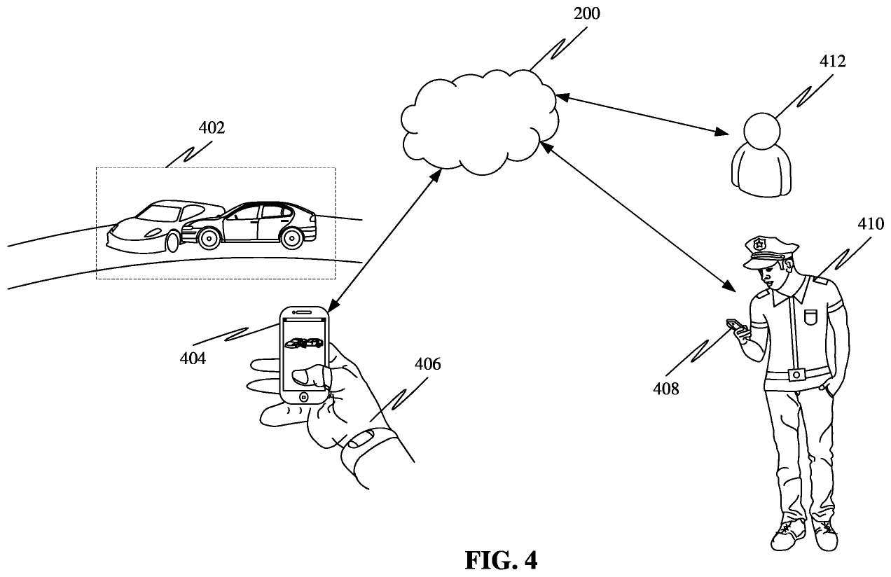

FIG. 2 is a block diagram representation of a system 200 of facilitating management of emergency situations, in accordance with some embodiments. Further, the emergency situations, in an instance, may include incidents such as (but not limited to) fire, an automobile accident (e.g. car accident 402 as shown in FIG. 4), a criminal activity, and/or a medical emergency caused by aforementioned incidents.

Further, the system 200 may include a communication device 202 configured for receiving a plurality of live video feeds related to the emergency situations from a plurality of user devices (such as user device 404, as shown in FIG. 4). Further, the plurality of user devices, in an instance, may capture the plurality of live video feeds using image capturing devices (such as, but not limited to, a camera). Further, the plurality of user devices, in an instance, may include a microphone and one or more sensors configured to capture physical, chemical and/or biological variables. Further, the plurality of user devices, in an instance, may include, but not limited to, smartphones, smartwatches, laptops, PCs, etc.

Further, the communication device 202 may be configured for transmitting the plurality of live video feeds and a ranking of the plurality of live video feeds to a security personnel device (such as security personnel device 408 as shown in FIG. 4). Further, the security personnel device, in an instance, may be any user device that may be operated by any security personnel (such as a police officer 410 and a 911 operator 412, as shown in FIG. 4) such as (but not limited to) local police stations and/or law enforcement officials.

Further, the plurality of live video feeds (such as all videos and/or pictures) taken by users (such as a citizen 406 as shown in FIG. 4) through the user device 404 and/or transmitted to the security personnel device 408 may be stored in a dashboard (such as databases 108) of the citizen 406 for a later date for prosecution reasons or to share with the other people. Further, in an instance, all video calls sent to Law enforcement/911 dispatchers may also be stored on the dashboard for later prosecution or suspect line-up. Further, in some embodiments, the citizen 406 (through the user device 404) may be allowed to transmit the plurality of live video feeds to the security personnel device 408 in real-time, for instance, by performing one or more of pressing a button (such as a panic button) on the user device 404, shaking the user device 404, and/or speaking a phrase near the user device 404 etc. Further, in some embodiments, the plurality of live video feeds that may be shared with the security personnel device 408, in an instance, may be in an encoded form in order to maintain privacy.

Further, in some embodiments, the communication device 202 may be configured for transmitting a user location and/or other user relevant data. For instance, the other user relevant data may include information such as (but not limited to) user's name, age, gender, occupation and so on.

Further, the system 200 may include a processing device 204 configured for analyzing the plurality of live video feeds to retrieve one or more video characteristics for each of live video feed in the plurality of live video feeds. Further, the one or more video characteristics may indicate a threat level associated with corresponding live video feed.

Further, the processing device 204 may be configured for prioritizing the plurality of live video feeds based on the one or more video characteristics to obtain the ranking of the plurality of live video feeds.

Further, in some embodiments, the processing device 204 may be configured for performing image analysis of the plurality of live video feeds to retrieve the one or more video characteristics. Further, the one or more video characteristics may include detecting one or more objects. In some embodiments, the one or more objects may include weapons, fire, injured people and, damaged vehicles. Further, the threat level may be determined based on the detected one or more objects. For instance, the threat level may be relatively higher for a live video feed that may include weapons (such as a machine gun, and/or a hand grenade).

Further, in some embodiments, the processing device 204 may be configured for performing one or more of compressing, segmenting and coding the plurality of live video feeds. Further, the plurality of live video feeds, in an instance, may employ formats such as (but not limited to) HTTP Live Streaming (also known as HLS), MPEG-DASH. Further, the processing device 204, in an instance, may be configured to codify video files in H.264 format and/or audio files in AAC, MP3, AC-3 and/or EC-3 format (encapsulated by MPEG-2 Transport Stream (TS) to carry). Further, the segmenting of the live video feeds, in an instance, may include dividing the MPEG-2 TS file into fragments of equal length in order to keep as “.ts” files. Further, the processing device, in an instance, may create an index file that may contain references of fragmented files, saved as .m3u8.

Further, in some embodiments, the security personnel device 408 may display the plurality of live video feeds based on the ranking of the plurality of live video feeds. For instance, the security personnel device 408 may be configured to display up to 24 live video feeds that may open and/or may reveal GPS location, name and/or other user relevant data associated with the user over a map based on GPS. For instance, the map may include (but not limited to) a high definition 3D map, Google Maps™, and terrain maps, etc.

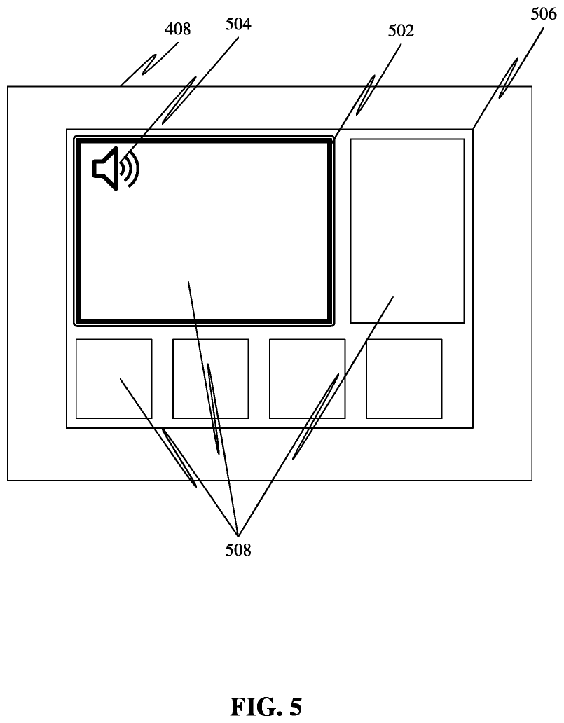

Further, in some embodiments, the security personnel device 408 may provide one or more of visual indicators 502 (as shown in FIG. 5) and sound indicators 504 (as shown in FIG. 5) for one or more live video feeds 508 (as shown in FIG. 5) in the plurality of live video feeds based on the ranking of the one or more live video feeds. For instance, the security personnel device 408 may provide visual indicator 502 (such as, but not limited to, highlighting and/or flashing of different colors) and/or sound indicators 504 (such as, but not limited to, audible tones with different intensity and/or frequency) on a map 506 so that an officer (such as the security personnel at a police station) may view and/or manage cluster of calls based on a highlighted severity of color/size associated with the visual indicator 502 and/or a degree of sound associated with the sound indicator 504.

Further, in some embodiments, security personnel (such as the police officer 410) with the security personnel device 408 may select a live video feed in the plurality of live video feeds to initiate a real-time communication with the user device 404 transmitting the live video feed. Further, the real-time communication, in an instance, may include an exchange of one or more voice and video content between the security personnel device 408 and the user device 404 transmitting the live video feed. For instance, the real-time communication may include (but not limited to) a voice chat, a video call, and/or a textual chat, etc. Further, in some embodiments, the security personnel (such as the police officer 410) may choose to text/call the citizen 406 and/or provide necessary aid.

Further, in some embodiments, the security personnel device 408 may display one or more of a name of the user of the user device 404, the location of the user device 404, the past record of the user of the user device 404, when the live video feed may be selected. Further, the real-time communication (such as Video calls), in an instance, may allow the security personnel (such as Law Enforcement agents or 911 dispatchers) to locate the user on a map. For instance, the video calls may include a map that may refer (by GPS) as to where the user may be currently located. Further, the security personnel, in an instance, may be allowed (through the security personnel device 408) to respond back (such as speak back) to the user (such as the citizen 406) associated with the user device 404. Further, the security personnel, in an instance, may be allowed to share one or more information with the user such as specific instructions in order to avoid any harm (and/or evacuation/escape route) as per the emergency situation.

Further, during the real-time communication (such as a video call), the security personnel may ask the user (such as a video caller) to zoom in and/or out through the user device (such as smartphones) associated with the user to help the security personnel to (for instance) view a person (and/or persons) or a suspect's face, help identify a vehicle or see a license plate clearer etc.

Further, in some embodiment, a user (such as the citizen 406) may be allowed to set-up a pin code (such as a 4-digit pin code) through the user device 404. Further, the pin code, in an instance, may be any code that may only be known to the user and/or may be used by the user to turn off the live video feed (and/or the real-time communication). Further, in a case, if the live video feed (and/or the real-time communication) is suddenly disconnected without the pin code entered by the user, then an alert (such as, but not limited to, a message and/or mail etc.) may be sent to the security personnel device 408 associated with the security personnel (such as, but not limited to, a law enforcement agent or 911). For instance, if a malicious person takes the user device 404 associated with the user and/or may try to turn off the live video feed (and/or the real-time communication), then the malicious person may not be able to disconnect without sending the alert to the security personnel device 408. Further, the alert may notify the security personnel (such as the police officer 410) that the real-time communication may be ended without the Pin code and/or the security personnel may need to reconnect with the user through the user device 404. Further, in another instance, the alert may allow the security personnel to send security units to a user location (such as last known GPS location of the user) when the real-time communication may be ended suspiciously and/or the malicious person on call may not be identified as an authorized citizen. Further, in some embodiments, the user's information (such as user's name, age, gender, occupation, location and so on), in an instance, may be kept confidential until the user may decide to send the plurality of live video feed (such as a video call and/or a picture) to the security personnel device 408 associated with the security personnel.

Further, in some embodiments, the security personnel, in an instance, may escalate a picture and/or video call being sent to the security personnel device 408 to State and/or Federal Law Enforcement entities as the video call may be taking place. Further, such escalation, in an instance, may save valuable time and/or help local Law Enforcement to deal with the emergency situation in a timely fashion with the help of State and Federal agents. For instance, the law enforcement may be able to decide a best course of action to take, saving valuable seconds and minutes that might save lives.

Further, in some embodiments, if the security personnel may fail to respond to the live video feed within a predetermined time period (e.g. 1 minute), a call may be automatically placed with a 911 operator. Further, the users, in an instance, may set the predetermined time period (through the user device) that may be stored in the dashboard of the user. For instance, the user may set the predetermined time period (say 1 minute), in order to set how long the Video Call may be played before dialing 911 in an event if the call goes unanswered by the security personnel. For instance, in the event, if the call goes unanswered due to no security personnel available, the system 200 may pull up and/or call 911 within the predetermined time period.

Further, in some embodiments, the communication device 202 may be configured for sending the plurality of live video feeds to other user devices. Accordingly, the user may be allowed to share the live video feed with one or more other users that may be in near surrounding of the user. For instance, the user may opt within the Video Call to share the live video feed with the one or more other users and/or an alert may be transmitted to the other user devices that may be associated with the one or more other users. Further, the alert, in an instance, may notify the one or more other users that a life-threatening event or crime may be in progress in near surrounding. For instance, in a case if a person (such as a prowler) is near the user's house, the user may interact with the user device (such as by pushing a share button) in order to share the live video feed (and/or the video call) with the one or more other users (such as nearby neighbors) who may be able to help law enforcement in identifying the person. Further, the user, in an instance, may share the live video feed on platforms such as (but not limited to) Facebook, Twitter, Instagram and so on. Further, in some embodiments, the user may be allowed to receive (through the user device) live crime/Emergency updates which may be sent from the security personnel device associated with the security personnel (such as local law enforcement departments), so the user may avoid following a particular route/area. Further, the security personnel device, in an instance, may be configured to transmit an active alert to the users (for instance, within a set radius determined by the law enforcement from a smartphone or an Administrators computer dashboard) that a Life-threatening event may be in progress near the users. Further, the active alert, in an instance, may have varying degrees of color and/or sound that may intensify based on a severity of the active alert. For instance, a pulsing sound like Amber Alert that may speed up based on the severity of the Active Alert. Further, in another instance, the active alert may be configured to notify the users the emergency situations such as (but not limited to) a Shooting in progress nearby or a bombing, fire, bridge collapse or any Life-Threatening situation telling the users to avoid this area, or in the case of a School shooting where to go and what to do etc.

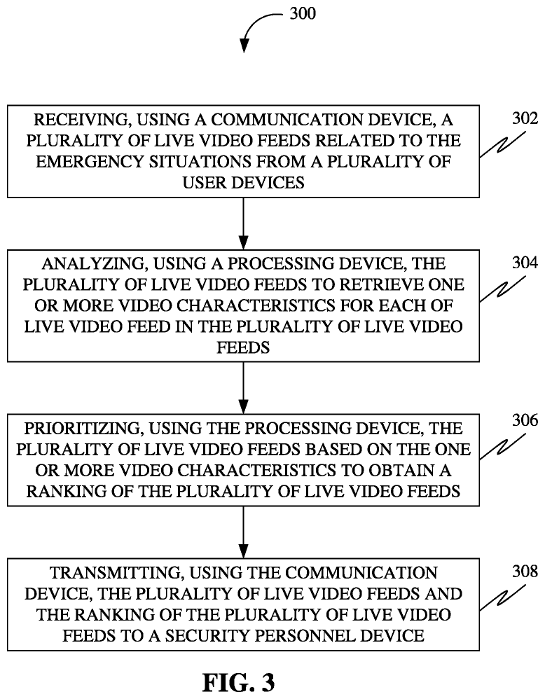

FIG. 3 is a flowchart of a method 300 of facilitating management of emergency situations, in accordance with some embodiments. Accordingly, at 302, the method 300 may include receiving, using a communication device (such as the communication device 202), a plurality of live video feeds related to the emergency situations from a plurality of user devices.

Further, at 304, the method 300 may include analyzing, using a processing device (such as the processing device 204), the plurality of live video feeds to retrieve one or more video characteristics for each of live video feed in the plurality of live video feeds. Further, the one or more video characteristics may indicate a threat level associated with corresponding live video feed. Further, in some embodiments, the analyzing may include performing, using the processing device, image analysis of the live video feeds to retrieve the one or more video characteristics. Further, the one or more video characteristics may include detecting one or more objects. Further, the threat level may be determined based on the detected one or more objects. Further, in some embodiments, the one or more objects may include weapons, fire, injured people and, damaged vehicles.

Further, at 306, the method 300 may include prioritizing, using the processing device, the plurality of live video feeds based on the one or more video characteristics to obtain a ranking of the plurality of live video feeds.

Further, at 308, the method 300 may include transmitting, using the communication device, the plurality of live video feeds and the ranking of the plurality of live video feeds to a security personnel device. In some embodiments, transmitting the plurality of live video feeds further may include performing, using the processing device, one or more of compressing, segmenting and coding the plurality of live video feeds.

Further, in some embodiments, the security personnel device may display the plurality of live video feeds based on the ranking of the plurality of live video feeds. Further, in some embodiments, the security personnel device may provide one or more of visual indicators and sound indicators for one or more live video feeds in the plurality of live video feeds based on the ranking of the one or more live video feeds. Further, in some embodiments, a security personnel with the security personnel device may select a live video feed in the plurality of live video feeds to initiate a real-time communication with the user device transmitting the live video feed. Further, in some embodiments, the security personnel device may display one or more of a name of the user of the user device, the location of the user device, the past record of the user of the user device, when the live video feed may be selected. Further, in some embodiments, if the security personnel may fail to respond to the live video feed within a predetermined time period, a call may be automatically placed with a 911 operator.

Further, in some embodiments, the transmitting the plurality of live video feeds may include sending, using the communication device, one or more of the plurality of live video feeds to other user devices.

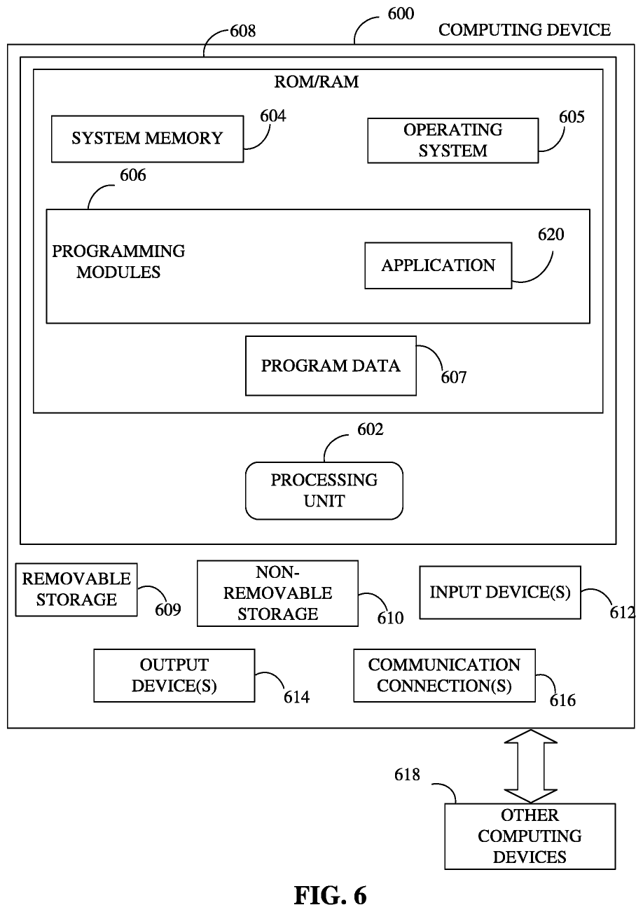

With reference to FIG. 6, a system consistent with an embodiment of the disclosure may include a computing device or cloud service, such as computing device 600. In a basic configuration, computing device 600 may include at least one processing unit 602 and a system memory 604. Depending on the configuration and type of computing device, system memory 604 may comprise, but is not limited to, volatile (e.g. random-access memory (RAM)), non-volatile (e.g. read-only memory (ROM)), flash memory, or any combination. System memory 604 may include operating system 605, one or more programming modules 606, and may include a program data 607. Operating system 605, for example, may be suitable for controlling computing device 600's operation. In one embodiment, programming modules 606 may include image-processing module, machine learning module. Furthermore, embodiments of the disclosure may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and non-volatile, removable and non-removable media implemented in any method or technology for storage of information, such as computer-readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, a location sensor, a camera, a biometric sensor, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 (e.g., application 620 such as a media player) may perform processes including, for example, one or more stages of methods, algorithms, systems, applications, servers, databases as described above. The aforementioned process is an example, and processing unit 602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method of facilitating management of emergency situations, the method comprising:
receiving, using a communication device, a plurality of live video feeds related to the emergency situations from a plurality of user devices;
analyzing, using a processing device, the plurality of live video feeds to retrieve one or more video characteristics for each of live video feed in the plurality of live video feeds, wherein the one or more video characteristics indicate a threat level associated with corresponding live video feed;
prioritizing, using the processing device, the plurality of live video feeds based on the one or more video characteristics to obtain a ranking of the plurality of live video feeds; and
transmitting, using the communication device, the plurality of live video feeds and the ranking of the plurality of live video feeds to a security personnel device.

2. The method of claim 1, wherein the analyzing includes performing, using the processing device, image analysis of the live video feeds to retrieve the one or more video characteristics, wherein the one or more video characteristics include detecting one or more objects, wherein the threat level is determined based on the detected one or more objects.

3. The method of claim 2, wherein the one or more objects include weapons, fire, injured people and damaged vehicles.

4. The method of claim 1, wherein transmitting the plurality of live video feeds further includes performing, using the processing device, one or more of compressing, segmenting and coding the plurality of live video feeds.

5. The method of claim 1, wherein the security personnel device displays the plurality of live video feeds based on the ranking of the plurality of live video feeds.

6. The method of claim 5, wherein the security personnel device provides one or more of visual indicators and sound indicators for one or more live video feeds in the plurality of live video feeds based on the ranking of the one or more live video feeds.

7. The method of claim 5, wherein a security personnel with the security personnel device selects a live video feed in the plurality of live video feeds to initiate a real-time communication with the user device transmitting the live video feed.

8. The method of claim 7, wherein the security personnel device displays one or more of a name of the user of the user device, the location of the user device, the past record of the user of the user device, when the live video feed is selected.

9. The method of claim 7, wherein if the security personnel fails to respond to the live video feed within a predetermined time period, a call is automatically placed with a 911 operator.

10. The method of claim 1, wherein the transmitting the plurality of live video feeds includes sending, using the communication device, one or more of the plurality of live video feeds to other user devices.

11. A system of facilitating management of emergency situations comprising:
a communication device configured for:
receiving a plurality of live video feeds related to the emergency situations from a plurality of user devices; and
transmitting the plurality of live video feeds and a ranking of the plurality of live video feeds to a security personnel device; and
a processing device configured for:
analyzing the plurality of live video feeds to retrieve one or more video characteristics for each of live video feed in the plurality of live video feeds, wherein the one or more video characteristics indicate a threat level associated with corresponding live video feed; and
prioritizing the plurality of live video feeds based on the one or more video characteristics to obtain the ranking of the plurality of live video feeds.

12. The system of claim 11, the processing device is further configured for performing image analysis of the plurality of live video feeds to retrieve the one or more video characteristics, wherein the one or more video characteristics include detecting one or more objects, wherein the threat level is determined based on the detected one or more objects.

13. The system of claim 12, wherein the one or more objects include weapons, fire, injured people and damaged vehicles.

14. The system of claim 11, wherein the processing device is further configured for performing one or more of compressing, segmenting and coding the plurality of live video feeds.

15. The system of claim 11, wherein the security personnel device displays the plurality of live video feeds based on the ranking of the plurality of live video feeds.

16. The system of claim 15, wherein the security personnel device provides one or more of visual indicators and sound indicators for one or more live video feeds in the plurality of live video feeds based on the ranking of the one or more live video feeds.

17. The system of claim 15, wherein a security personnel with the security personnel device selects a live video feed in the plurality of live video feeds to initiate a real-time communication with the user device transmitting the live video feed.

18. The system of claim 17, wherein the security personnel device displays one or more of a name of the user of the user device, the location of the user device, the past record of the user of the user device, when the live video feed is selected.

19. The system of claim 17, wherein if the security personnel fails to respond to the live video feed within a predetermined time period, a call is automatically placed with a 911 operator.

20. The system of claim 11, wherein the communication device is configured for sending the plurality of live video feeds to other user devices.
